(19) United States
(12) Patent Application Publication
(10) Pub. No.: US 2009/0271570 A1
(43) Pub. Date: Oct. 29, 2009

(54) Content-Addressable Memory Lookup Operations with Error Detection

(75) Inventors: Barry Scott BURNS, Cary, NC (US); Chirag SHROFF, Apex, NC (US)

Correspondence Address: THE LAW OFFICE OF KIRK D. WILLIAMS, PO BOX 39425, DENVER, CO, 80239-0425, US

(73) Assignee: Cisco Technology, Inc., a corporation of California, San Jose, CA (US)

(21) Appl. No.: 12/111,436

(22) Filed: Apr. 29, 2008

(51) Int. Cl. G06F 12/00

(52) U.S. Cl. 711/108; 711/E12.001

(57) ABSTRACT

Disclosed are, inter alia, methods, apparatus, computer-storage media, mechanisms, and means associated with content-addressable memory lookup operations with error detection. Lookup operations are performed on two identical sets of content-addressable memory entries to identify two lookup results. An error detection operation is performed on the highest-priority matching entry of each set of content-addressable memory entries. An overall lookup result is determined based on the lookup and error detection results.

### RESEARCH OR DEVELOPMENT

The U.S. Government has a paid-up license in this invention and the right in limited circumstances to require the patent owner to license others on reasonable terms as provided for by the terms of contract No. FA8808-05-R-002 awarded by the United States Air Force.

### TECHNICAL FIELD

The present disclosure relates generally to content-addressable memories and their operation in determining a lookup result when there may be an error in one or more of their entries.

### BACKGROUND

The communications industry is rapidly changing to adjust to emerging technologies and ever increasing customer demand. This customer demand for new applications and increased performance of existing applications is driving communications network and system providers to employ networks and systems having greater speed and capacity (e.g., greater bandwidth). In trying to achieve these goals, a common approach taken by many communications providers is to use packet switching technology. Note, nothing described or referenced in this document is admitted as prior art to this application unless explicitly so stated.

Associative memories are very useful in performing packet classification operations. As with most any system, errors can occur. For example, array parity errors can occur in certain content-addressable memories as a result of failure-in-time or other single event upset induced errors which are typical of semiconductor devices. When a packet classification lookup operation is performed on an associative memory with corrupted entries, a bit error in an entry can result in a false hit, or a false miss. A false hit occurs when the corrupted value of an entry matches the lookup word when it otherwise would not match that entry (and thus another entry or no entry should have been matched). A false miss occurs when an entry should have been matched except for the corruption in the entry. This could result in no entry being matched or another lower-priority entry being matched. When these lookup operations are used for packet classification, an incorrect match or miss presents a problem especially when identifying a route or performing a security classification.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1A illustrates a block diagram of an apparatus used in one embodiment;

FIG. 1B illustrates a block diagram of content-addressable memory entries used in one embodiment;

FIG. 1C illustrates a process performed in one embodiment;

FIG. 2A illustrates a block diagram of an apparatus used in one embodiment;

FIG. 2B illustrates a block diagram of content-addressable memory entries used in one embodiment;

FIG. 2C illustrates a process performed in one embodiment; and

FIG. 3 illustrates an example system or component used in one embodiment.

### DESCRIPTION OF EXAMPLE EMBODIMENTS

### 1. Overview

Disclosed are, inter alia, methods, apparatus, computer-storage media, mechanisms, and means associated with content-addressable memory lookup operations with error detection. One embodiment performs a lookup operation with a lookup word on both a first plurality of content-addressable memory (CAM) entries and a second plurality of CAM entries in order to generate a first CAM result from the first plurality of CAM entries and a second CAM result from the second plurality of CAM entries, with the first and second plurality of CAM entries being the same and ordered in a same priority order. A determination of which of the first or second CAM result is correct is performed and produces said determined correct first or second CAM result as the lookup result; wherein said generated first and second CAM results do not correspond to the same CAM entry respectively in the first and second plurality of CAM entries.

In one embodiment, said determining which of the first or second CAM result is correct includes determining the first CAM result is correct in response to: (a) performing an error detection operation on a first CAM entry corresponding to the first CAM result to identify no error, (b) performing an error detection operation on a second CAM entry corresponding to the second CAM result to identify no error, and (c) identifying that the first CAM result corresponds to a higher-priority CAM entry in said priority order of said CAM entries than the CAM entry corresponding to the second CAM result. In one embodiment, the first and second plurality of CAM entries are stored in different ternary content-addressable memories. In one embodiment, the first and second plurality of CAM entries are stored in different binary content-addressable memories.

One embodiment includes: determining the first CAM result is correct and correcting the CAM entry in the second plurality of CAM entries at the same position in said priority order as the CAM entry in the first plurality of CAM entries corresponding to the first CAM in response to: (a) performing an error detection operation on a first CAM entry corresponding to the first CAM result to identify no error, (b) performing an error detection operation on a second CAM entry corresponding to the second CAM result to identify no error, and (c) identifying that the first CAM result corresponds to a higher-priority CAM entry in said priority order of said CAM entries than the CAM entry corresponding to the second CAM result. One embodiment comprises programming the plurality of CAM entries into a first CAM and the second plurality of CAM entries into a second CAM; wherein same entries of the first and second plurality of entries are stored at same addresses within the first and second CAMs. In one embodiment, said determining which of the first or second CAM result is correct includes determining the first CAM result is correct in response to: (a) performing an error detection operation on a first CAM entry corresponding to the first CAM result to identify no error, and (b) performing an error detection operation on a second CAM entry corresponding to the second CAM result to identify an error. In one embodiment, said determining the first CAM result is correct and correcting the CAM entry in the second plurality of CAM entries at the same position in said priority order as the CAM entry in the first plurality of CAM entries corresponding to the first CAM in response to: (a) performing an error detection operation on a first CAM entry corresponding to the first CAM result to identify no error, and (b) performing an error detection operation on a second CAM entry corresponding to the second CAM result to identify an error.

### 2. Description

Disclosed are, inter alia, methods, apparatus, computer-storage media, mechanisms, and means associated with content-addressable memory lookup operations with error detection. Embodiments described herein include various elements and limitations, with no one element or limitation contemplated as being a critical element or limitation. Each of the claims individually recites an aspect of the invention in its entirety. Moreover, some embodiments described may include, but are not limited to, inter alia, systems, networks, integrated circuit chips, embedded processors, ASICs, methods, and computer-readable media containing instructions. One or multiple systems, devices, components, etc. may comprise one or more embodiments, which may include some elements or limitations of a claim being performed by the same or different systems, devices, components, etc. The embodiments described hereinafter embody various aspects and configurations within the scope and spirit of the invention, with the figures illustrating exemplary and non-limiting configurations. Note, computer-readable media and means for performing methods and processing block operations are disclosed and are in keeping with the extensible scope and spirit of the invention.

Note, the steps, connections, and processing of signals and information illustrated in the figures, including, but not limited to any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of read the value, process said read value—the value must be obtained prior to processing it, although some of the associated processing may be performed prior to, concurrently with, and/or after the read operation).

The term “one embodiment” is used herein to reference a particular embodiment, wherein each reference to “one embodiment” may refer to a different embodiment, and the use of the term repeatedly herein in describing associated features, elements and/or limitations does not establish a cumulative set of associated features, elements and/or limitations that each and every embodiment must include, although an embodiment typically may include all these features, elements and/or limitations. In addition, the terms “first,” “second,” etc. are typically used herein to denote different units (e.g., a first element, a second element). The use of these terms herein does not necessarily connote an ordering such as one unit or event occurring or coming before another, but rather provides a mechanism to distinguish between particular units. Moreover, the phrases “based on x” and “in response to x” are used to indicate a minimum set of items “x” from which something is derived or caused, wherein “x” is extensible and does not necessarily describe a complete list of items on which the operation is performed, etc. Additionally, the phrase “coupled to” is used to indicate some level of direct or indirect connection between two elements or devices, with the coupling device or devices modifying or not modifying the coupled signal or communicated information. Moreover, the term “or” is used herein to identify a selection of one or more, including all, of the conjunctive items. Additionally, the transitional term “comprising,” which is synonymous with “including,” “containing,” or “characterized by,” is inclusive or open-ended and does not exclude additional, unrecited elements or method steps.

Disclosed are, inter alia, methods, apparatus, computer-storage media, mechanisms, and means associated with content-addressable memory lookup operations with error detection. One embodiment performs a lookup operation with a lookup word on both a first plurality of content-addressable memory (CAM) entries and a second plurality of CAM entries in order to generate a first CAM result from the first plurality of CAM entries and a second CAM result from the second plurality of CAM entries, with the first and second plurality of CAM entries being the same and ordered in a same priority order. A determination of which of the first or second CAM result is correct is performed and produces said determined correct first or second CAM result as the lookup result; wherein said generated first and second CAM results do not correspond to the same CAM entry respectively in the first and second plurality of CAM entries.

In one embodiment, said determining which of the first or second CAM result is correct includes determining the first CAM result is correct in response to: (a) performing an error detection operation on a first CAM entry corresponding to the first CAM result to identify no error, (b) performing an error detection operation on a second CAM entry corresponding to the second CAM result to identify no error, and (c) identifying that the first CAM result corresponds to a higher-priority CAM entry in said priority order of said CAM entries than the CAM entry corresponding to the second CAM result. In one embodiment, the first and second plurality of CAM entries are stored in different ternary content-addressable memories. In one embodiment, the first and second plurality of CAM entries are stored in different binary content-addressable memories.

One embodiment includes: determining the first CAM result is correct and correcting the CAM entry in the second plurality of CAM entries at the same position in said priority order as the CAM entry in the first plurality of CAM entries corresponding to the first CAM in response to: (a) performing an error detection operation on a first CAM entry corresponding to the first CAM result to identify no error, (b) performing an error detection operation on a second CAM entry corresponding to the second CAM result to identify no error, and (c) identifying that the first CAM result corresponds to a higher-priority CAM entry in said priority order of said CAM entries than the CAM entry corresponding to the second CAM result. One embodiment comprises programming the plurality of CAM entries into a first CAM and the second plurality of CAM entries into a second CAM; wherein same entries of the first and second plurality of entries are stored at same addresses within the first and second CAMs. In one embodiment, said determining which of the first or second CAM result is correct includes determining the first CAM result is correct in response to: (a) performing an error detection operation on a first CAM entry corresponding to the first CAM result to identify no error, and (b) performing an error detection operation on a second CAM entry corresponding to the second CAM result to identify an error. In one embodiment, said determining the first CAM result is correct and correcting the CAM entry in the second plurality of CAM entries at the same position in said priority order as the CAM entry in the first plurality of CAM entries corresponding to the first CAM in response to: (a) performing an error detection operation on a first CAM entry corresponding to the first CAM result to identify no error, and (b) performing an error detection operation on a second CAM entry corresponding to the second CAM result to identify an error.

One embodiment includes: means for performing a lookup operation with a lookup word on both a first plurality of content-addressable memory (CAM) entries and a second plurality of CAM entries in order to generate a first CAM result from the first plurality of CAM entries and a second CAM result from the second plurality of CAM entries, with the first and second plurality of CAM entries being the same and ordered in a same priority order; and means for determining which of the first or second CAM result is correct and producing said determined correct first or second CAM result as the lookup result; wherein said generated first and second CAM results do not correspond to the same CAM entry respectively in the first and second plurality of CAM entries.

In one embodiment, said means for determining which of the first or second CAM result is correct includes means for determining the first CAM result is correct in response to: (a) performing an error detection operation on a first CAM entry corresponding to the first CAM result to identify no error, (b) performing an error detection operation on a second CAM entry corresponding to the second CAM result to identify no error, and (c) identifying that the first CAM result corresponds to a higher-priority CAM entry in said priority order of said CAM entries than the CAM entry corresponding to the second CAM result. One embodiment comprises: means for determining the first CAM result is correct and means for correcting the CAM entry in the second plurality of CAM entries at the same position in said priority order as the CAM entry in the first plurality of CAM entries corresponding to the first CAM; wherein said means for determining the first CAM result is correct and said means for correcting the CAM entry in the second plurality of CAM entries at the same position in said priority order as the CAM entry in the first plurality of CAM entries corresponding to the first CAM are both responsive to: a) means for performing an error detection operation on a first CAM entry corresponding to the first CAM result to identify no error, (b) means for performing an error detection operation on a second CAM entry corresponding to the second CAM result to identify no error, and (c) means for identifying that the first CAM result corresponds to a higher-priority CAM entry in said priority order of said CAM entries than the CAM entry corresponding to the second CAM result. In one embodiment, said means for determining which of the first or second CAM result is correct includes: means for performing an error detection operation on a first CAM entry corresponding to the first CAM result to identify no error; and means for performing an error detection operation on a second CAM entry corresponding to the second CAM result to identify an error. One embodiment includes: means for determining the first CAM result is correct and for correcting the CAM entry in the second plurality of CAM entries at the same position in said priority order as the CAM entry in the first plurality of CAM entries corresponding to the first CAM in response to: (a) performing an error detection operation on a first CAM entry corresponding to the first CAM result to identify no error, and (b) performing an error detection operation on a second CAM entry corresponding to the second CAM result to identify an error.

One embodiment includes: a first content-addressable memory (CAM) configured to perform a lookup operation on its entries with a lookup word in order to produce a first CAM result and a first error code value; a second CAM configured to perform a lookup operation on its entries with the lookup word in order to produce a second CAM result and a second error code value, wherein the first and second CAMs are programmed with same entries at the same locations respectively within the first and second CAMS; and a result analyzer configured to determine a lookup result based on the first and second CAM results and the first and second error code values, wherein said configuration of the result analyzer includes: when said generated first and second CAM results do not correspond to a same entry position respectively in the first and second CAMs, determining the first CAM result as the lookup result in response to: (a) the first error code value identifying no error, (b) the second error code value identifying no error, and (c) the first CAM result corresponds to a higher-priority CAM entry than the second CAM result.

In one embodiment, wherein the first and second CAM are ternary content-addressable memories. In one embodiment, the apparatus is configured to correct the CAM entry in the second CAM at the position corresponding to the first CAM result in response to said determination of the first CAM result as the lookup result. In one embodiment, said configuration of the result analyzer includes: determining the first CAM result is correct in response to: (a) the first error code value identifying no error, and (b) the second error code value identifying an error; and wherein the apparatus is configured to correct the entry in the second CAM at the position corresponding to the second CAM result in response to the second error code value identifying an error.

One embodiment includes: a first content-addressable memory (CAM) configured to perform a lookup operation on its entries with a lookup word in order to produce a first CAM result; a second CAM configured to perform a lookup operation on the lookup word in order to produce a second CAM result, wherein the first and second CAMs are programmed with same entries in the same priority-order; and a result analyzer configured to determine a first error code value associated with the first CAM result and a second error code value associated with the second CAM result; and to determine a lookup result based on the first and second CAM results and the first and second error code values, wherein said configuration of the result analyzer includes: when said generated first and second CAM results do not correspond to a same entry position respectively in the first and second CAMs, determining the first CAM result as the lookup result in response to: (a) the first error code value identifying no error, (b) the second error code value identifying no error, and (c) the first CAM result corresponds to a higher-priority CAM entry than the second CAM result.

In one embodiment, the apparatus is configured to correct the CAM entry in the second CAM at the position corresponding to the first CAM result in response to said determination of the first CAM result as the lookup result. In one embodiment, said configuration of the result analyzer includes: determining the first CAM result is correct in response to: (a) the first error code value identifying no error, and (b) the second error code value identifying an error; and wherein the apparatus is configured to correct the entry in the second CAM at the position corresponding to the second CAM result in response to the second error code value identifying an error.

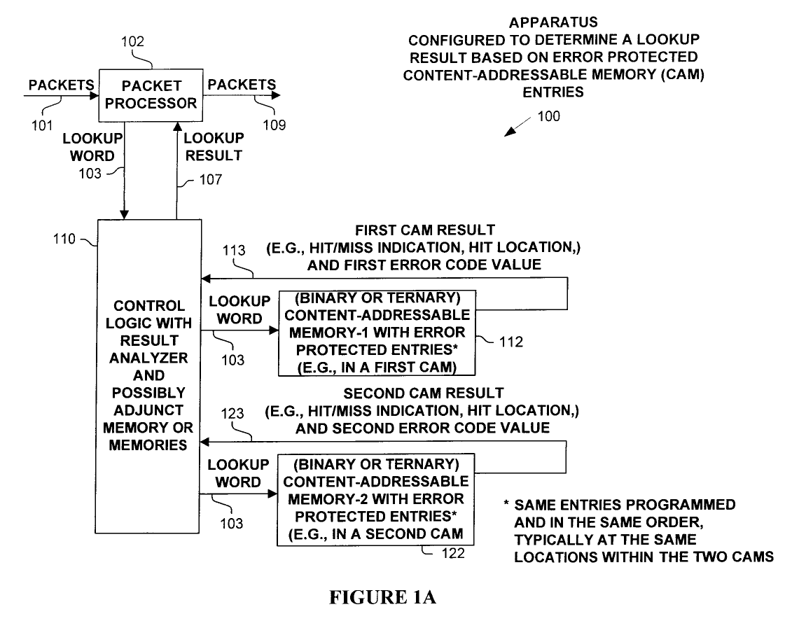

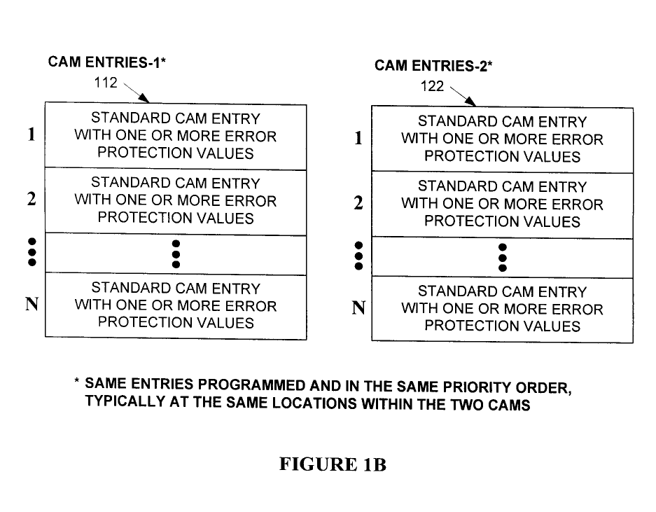

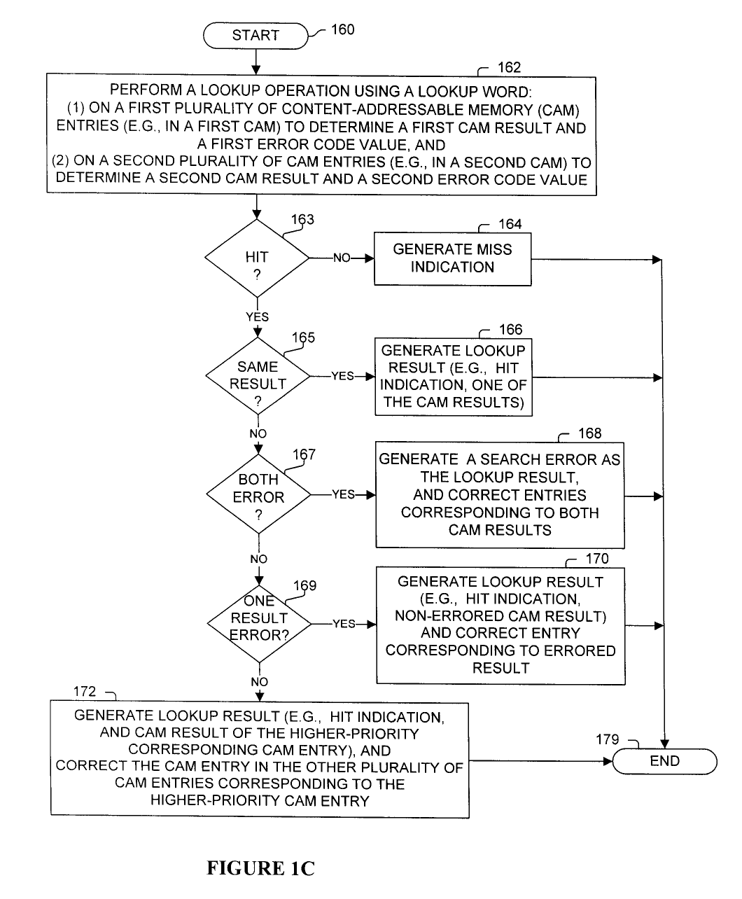

Turning to the figures, FIG. 1A illustrates a block diagram of one embodiment of an apparatus 100 configured to determine a lookup result 107 based on error protected content-addressable memory (CAM) entries 112, 122 (e.g., with CAM entries 112 stored in a first CAM, and CAM entries 122 stored in a second CAM). In this particular embodiment, lookup words (103) are generated from packets 101 and lookup results (107) are used to process packets (109). Other embodiments generate a lookup word 103 and use lookup result 107 in other computer and/or communications contexts and/or systems.

Briefly turning to FIG. 1B, illustrated are CAM entries 112 and 122 used in one embodiment. CAM entries 112 are a duplicate of CAM entries 122, with each being stored or otherwise maintained in a same priority order. CAM entries 112 and 122 are standard CAM entries (e.g., binary, ternary, or other CAM entries) supplemented with an error detecting or error protecting code so that an error detection operation can be performed on each entry. In this manner and as part of a lookup operation, a CAM can check the highest-priority matching CAM entry to see if it has at least one error, and to generate an error code value at least identifying whether or not there was a detected error. This error detection operation can be performed using one of an extensible number of implementations, such as, but not limited to via logic, or configuring the CAM (or other entity) to read the highest-priority matching CAM entry and an associated error detection or correction code, and then perform the error detection operation.

If an error correcting code is used, a detected error can be corrected based on an error protecting code, otherwise, the error can be corrected by simply overwriting the errored entry with the originally programmed value. In one embodiment, the portion of a CAM entry used to match against the lookup word does not include the error protecting or detecting code; while in one embodiment it does (and the lookup word is accordingly adjusted). In one embodiment, CAM entries 112 and CAM entries 122 are stored in different CAMs; while in one embodiment, they are stored in a same CAM configured to perform individual lookup operations on each of CAM entries 112 and 122.

Note, error-correcting and error-detecting codes are well-known. For example, assume a codeword contains n bits of which m are data bits and r are error-correcting or error-detecting bits (e.g., redundant or check bits), with n=m+r. There are many well-known ways to generate the error-detecting and error-correcting bits. Given two codewords, it is possible to determine how many bits differ (e.g., by exclusively-OR'ing or one bit summing the corresponding bits of the two codewords and summing these results). The number of bit positions in which two codewords or a set of codewords differ is called the Hamming distance. A Hamming distance of d, means that it will require d single-bit errors to convert one codeword to another codeword. To detect j errors, a Hamming distance of j+1 is required because with such a code, there is no way that j single-bit errors can change a valid codeword into another valid codeword. Similarly, to correct j errors, a distance 2j+1 code is required because that way the legal codewords are so far apart that even with j changes, the original codeword is still closer than any other codeword, so it can be uniquely determined.

Returning to the description of FIG. 1A, packets 101 are received by packet processor 102, which determines lookup word 103 on which to perform a lookup operation on CAM entries 112 and 122. Lookup word 103 is provided to control logic 110.

Control logic 110 includes a result analyzer and possibly one or more adjunct memories for determining an action to be taken based on the result of a lookup operation. Control logic 110 initiates lookup operations on CAM entries 112 and 122 using the same lookup word 103 to respectively generate a first CAM result 113 and a second CAM result 123. In one embodiment, each of these CAM results 113, 123 includes a hit/miss indication; and if there is a hit (i.e., a match is detected on one or more of the entries): an identification of the highest-priority matching entry, and an error code value identifying at least whether or not an error detection operation performed on the matching CAM entry identified an error. The result analyzer portion of control logic 110 processes the first and second CAM results to generate lookup result 107. In one embodiment, lookup result 107 includes a hit or miss indication. In one embodiment, if a valid matching entry was determined, lookup result 107 includes either an identification of the matching entry (e.g., the address of the valid matching entry in a CAM), or an action value retrieved from an adjunct memory based on the valid matching entry. In one embodiment, lookup result 107 includes an identification of whether zero, one or two errored entries were detected during the lookup operations.

Note, as discussed supra and as used herein, a lookup result corresponding to a valid matching entry may include an identification of a matching entry (e.g., the address of the matching entry in a CAM) and/or a value derived based of a valid matching entry (e.g., a value retrieved from an adjunct memory at a location corresponding to the address of the matching entry in a CAM).

Packet processor 202 typically processes one or more packets (109) based on each lookup result 107.

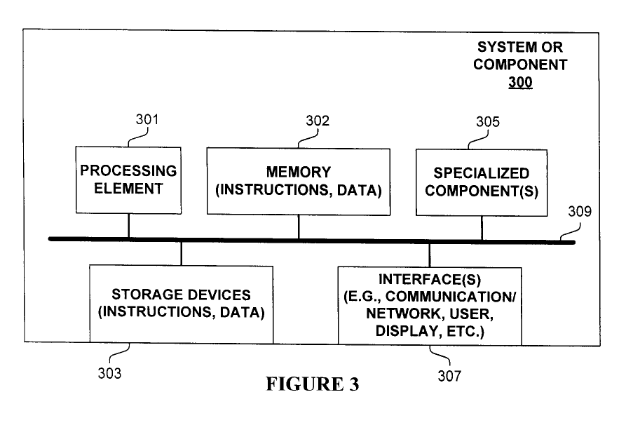

FIG. 1 C illustrates a process used in one embodiment for performing the lookup operations on two sets of identical CAM entries in order to determine a lookup result (such as, but not limited to using the apparatus illustrated in FIG. 1A or FIG. 3).

Processing begins with process block 160. In process block 162, a lookup operation is performed based on a lookup word: (1) on a first plurality of CAM entries to determine a first CAM result and a first error code value; and (2) on a second plurality of CAM entries to determine a second CAM result and a second error code value. As determined in process block 163, if no hit was detected in either the first or second plurality of entries, then in process block 164, a miss (e.g., no hit) indication is generated as the lookup result.

Otherwise, as determined in process block 165, if a same result (e.g., the same entry was matched in both the first plurality of entries and in the second plurality of entries), then in process block 166, the lookup result is generated, which typically includes a hit indication and an identification of a highest-priority matching entry in either of the first or second plurality of entries (which may be an address of the matching entry in one of the CAMs) and/or a value determined based on the matching entry (e.g., from a lookup operation in an adjunct memory based on an address of the matching entry).

Otherwise, as determined in process block 167, if both of the first and second error code values identify an error, then in process block 168, a search error is identified as the lookup result, and the determined matching entry in each of the first and second plurality of CAM entries is updated to remove the respective error.

Otherwise, as determined in process block 169, if only one of the first and second error code values identifies an error, then in process block 170, the lookup result is generated indicating a hit condition and the entry without the error as the matching entry, and the entry identified as having an error is corrected.

Otherwise, in process block 172, two different matching entries have been identified, and neither of them is identified as being in error. The lookup result is generated indicating a hit condition and the higher-priority entry of the two identified entries is identified as the lookup result; and the entry in the other plurality of CAM entries at the same position in the priority order as the identified lookup result is corrected.

Processing of the flow diagram of FIG. 1C is complete as indicated by process block 179.

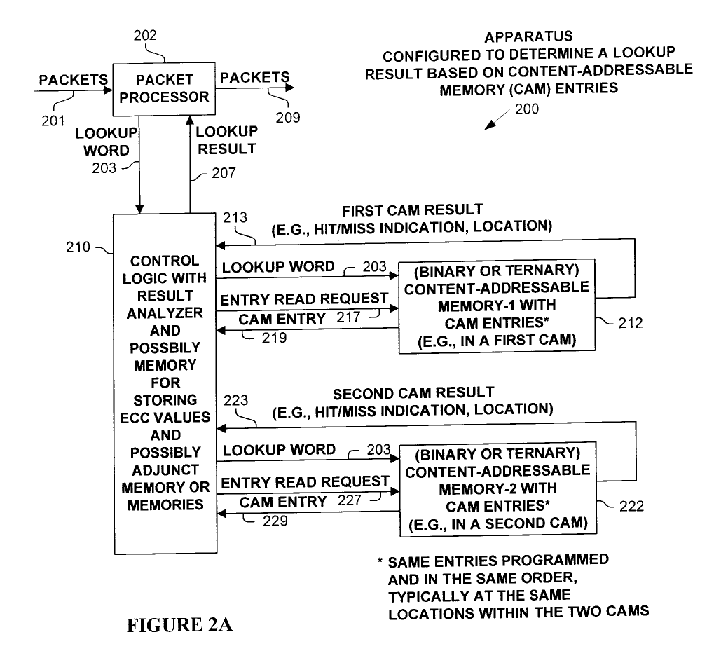

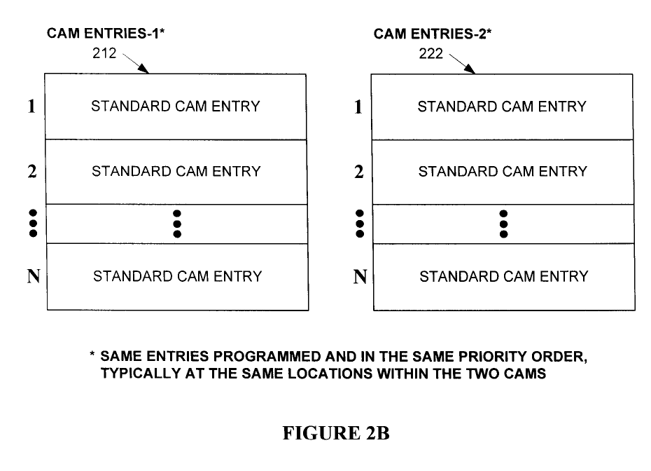

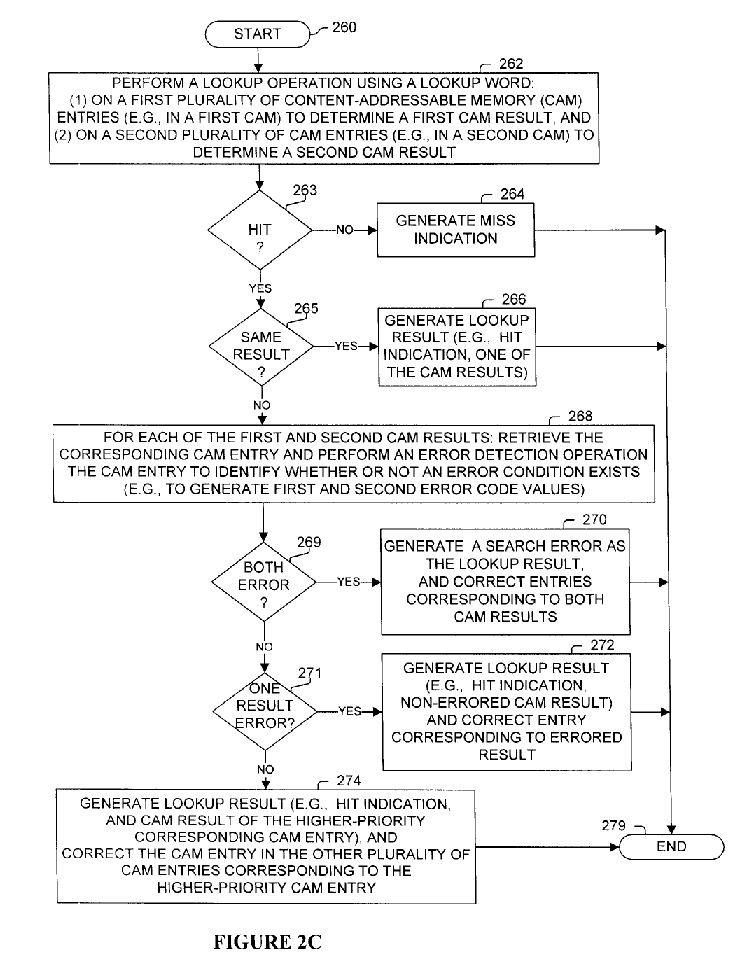

Note, the embodiments described in relation to FIGS. 2A-C are similar to those embodiments described in relation to FIGS. 1A-C, with a difference being that the first and second CAM results generated by the lookup operation on the CAM entries (e.g., generated by one or more CAMs storing these entries) illustrated in FIG. 1A include the first and second error code values; while control logic 210 illustrated in FIG. 2A determines these values.

FIG. 2A illustrates a block diagram of one embodiment of an apparatus 200 configured to determine a lookup result 207 based on content-addressable memory (CAM) entries 212, 222 (e.g., with CAM entries 212 stored in a first CAM, and CAM entries 222 stored in a second CAM). In this particular embodiment, lookup words (203) are generated from packets 201 and lookup results (207) are used to process packets (209). Other embodiments generate a lookup word 203 and use lookup result 207 in other computer and/or communications contexts and/or systems.

Briefly turning to FIG. 2B, illustrated are CAM entries 212 and 222 used in one embodiment. CAM entries 212 are a duplicate of CAM entries 222, with each being stored or otherwise maintained in a same priority order. CAM entries 212 and 222 are typically standard CAM entries (e.g., binary, ternary, or other CAM entries). However, in one embodiment, these CAM entries include a memory storage location configured for storing an error detecting or error protecting code (e.g., similar to the entries shown in FIG. 1B), which can also be read along with a CAM entry (rather than from a separate memory, such as in control logic 210).

Returning to the description of FIG. 2A, packets 201 are received by packet processor 202, which determines lookup word 203 on which to perform a lookup operation on CAM entries 212 and 222. In one embodiment, CAM entries 212 and CAM entries 222 are stored in different CAMs; while in one embodiment, they are stored in a same CAM configured to perform individual lookup operations on each of CAM entries 212 and 222.

Lookup word 203 is provided to control logic 210. Control logic 210 includes a result analyzer, possibly memory for storing error checking and/or correcting code values, and possibly one or more adjunct memories for determining an action to be taken based on the result of a lookup operation. Control logic 210 initiates lookup operations on CAM entries 212 and 222 using the same lookup word 203 to respectively generate a first CAM result 213 and a second CAM result 223. In one embodiment, each of these CAM results 213, 223 includes a hit/miss indication; and if there is a hit (i.e., a match is detected on one or more of the entries), an identification of the highest-priority matching entry.

Control logic 210 receives the first and second CAM results 213, 223, and for each of these results 213, 223 identifying a hit condition, retrieves (217/219, 227/229) the corresponding CAM entry and its corresponding error protection code (e.g., from a separate memory), and performs an error detection operation on the retrieved entry and error protection code to identify whether or not there is an error (e.g., identifies the first error code value for the first CAM result and/or the second error code value for the second CAM result). The result analyzer portion of control logic 210 processes the first and second CAM results and first and second error code values (if generated) to generate lookup result 207. In one embodiment, lookup result 207 includes a hit or miss indication. In one embodiment, if a valid matching entry was determined, lookup result 207 includes either an identification of the matching entry (e.g., the address of the valid matching entry in a CAM), or an action value retrieved from an adjunct memory based on the valid matching entry. In one embodiment, lookup result 207 includes an identification of whether zero, one or two errored entries were detected during the lookup operations.

Packet processor 202 typically processes one or more packets (209) based on each lookup result 207.

FIG. 2C illustrates a process used in one embodiment for performing the lookup operations on two sets of identical CAM entries in order to determine a lookup result (such as, but not limited to using the apparatus illustrated in FIG. 2A or FIG. 3).

Processing begins with process block 260. In process block 262, a lookup operation is performed based on a lookup word: (1) on a first plurality of CAM entries to determine a first CAM result; and (2) on a second plurality of CAM entries to determine a second CAM result. As determined in process block 263, if no hit was detected in either the first or second plurality of entries, then in process block 264, a miss (e.g., no hit) indication is generated as the lookup result.

Otherwise, as determined in process block 265, if a same result (e.g., the same entry was matched in both the first plurality of entries and in the second plurality of entries), then in process block 266, the lookup result is generated, which typically includes a hit indication and an identification of a highest-priority matching entry in either of the first or second plurality of entries (which may be an address of the matching entry in one of the CAMs) and/or a value determined based on the matching entry (e.g., from a lookup operation in an adjunct memory based on an address of the matching entry).

In process block 268, the CAM entries corresponding to each of the first and second CAM results are retrieved along with their associated error protection code, and an error detection operation is performed on each of these CAM entries to generate the first error code value and the second error code value, respectively.

As determined in process block 269, if both of the first and second error code values identify an error, then in process block 270, a search error is identified as the lookup result, and the determined matching entry in each of the first and second plurality of CAM entries is updated to remove the respective error.

Otherwise, as determined in process block 271, if only one of the first and second error code values identifies an error, then in process block 272, the lookup result is generated indicating a hit condition and the entry without the error as the matching entry, and the entry identified as having an error is corrected.

Otherwise, in process block 274, two different matching entries have been identified, and neither of them is identified as being in error. The lookup result is generated indicating a hit condition and the higher-priority entry of the two identified entries is identified as the lookup result; and the entry in the other plurality of CAM entries at the same position in the priority order as the identified lookup result is corrected.

Processing of the flow diagram of FIG. 2C is complete as indicated by process block 279.

FIG. 3 is block diagram of a system or component 300 used in one embodiment, such as part of control logic and/or a packet processor. In one embodiment, system or component 300 performs one or more processes corresponding to one of the flow diagrams illustrated or otherwise described herein.

In one embodiment, system or component 300 includes a processing element 301, memory 302, storage devices 303, specialized components 305 (e.g. optimized hardware such as one or more content-addressable memories, etc.), and interface(s) 307 for communicating information (e.g., sending and receiving packets, user-interfaces, displaying information, communicating with external devices such as content-addressable memories, etc.), which are typically communicatively coupled via one or more communications mechanisms 309, with the communications paths typically tailored to meet the needs of the application.

Various embodiments of component 300 may include more or less elements. The operation of component 300 is typically controlled by processing element 301 using memory 302 and storage devices 303 to perform one or more tasks or processes. Memory 302 is one type of computer-readable/computer-storage medium, and typically comprises random access memory (RAM), read only memory (ROM), flash memory, integrated circuits, and/or other memory components. Memory 302 typically stores computer-executable instructions to be executed by processing element 301 and/or data which is manipulated by processing element 301 for implementing functionality in accordance with an embodiment. Storage devices 303 are another type of computer-readable medium, and typically comprise solid state storage media, disk drives, diskettes, networked services, tape drives, and other storage devices. Storage devices 303 typically store computer-executable instructions to be executed by processing element 301 and/or data which is manipulated by processing element 301 for implementing functionality in accordance with an embodiment.

In view of the many possible embodiments to which the principles of our invention may be applied, it will be appreciated that the embodiments and aspects thereof described herein with respect to the drawings/figures are only illustrative and should not be taken as limiting the scope of the invention. For example, and as would be apparent to one skilled in the art, many of the process block operations can be re-ordered to be performed before, after, or substantially concurrent with other operations. Also, many different forms of data structures could be used in various embodiments. The invention as described herein contemplates all such embodiments as may come within the scope of the following claims and equivalents thereof.

What is claimed is:

1. A method, comprising:
performing a lookup operation with a lookup word on both a first plurality of content-addressable memory (CAM) entries and a second plurality of CAM entries in order to generate a first CAM result from the first plurality of CAM entries and a second CAM result from the second plurality of CAM entries, with the first and second plurality of CAM entries being the same and ordered in a same priority order; and
determining which of the first or second CAM result is correct and producing said determined correct first or second CAM result as the lookup result; wherein said generated first and second CAM results do not correspond to the same CAM entry respectively in the first and second plurality of CAM entries.

2. The method of claim 1, wherein said determining which of the first or second CAM result is correct includes determining the first CAM result is correct in response to: (a) performing an error detection operation on a first CAM entry corresponding to the first CAM result to identify no error, (b) performing an error detection operation on a second CAM entry corresponding to the second CAM result to identify no error, and (c) identifying that the first CAM result corresponds to a higher-priority CAM entry in said priority order of said CAM entries than the CAM entry corresponding to the second CAM result.

3. The method of claim 2, wherein the first and second plurality of CAM entries are stored in different ternary content-addressable memories.

4. The method of claim 2, wherein the first and second plurality of CAM entries are stored in different binary content-addressable memories.

5. The method of claim 1, comprising: determining the first CAM result is correct and correcting the CAM entry in the second plurality of CAM entries at the same position in said priority order as the CAM entry in the first plurality of CAM entries corresponding to the first CAM in response to: (a) performing an error detection operation on a first CAM entry corresponding to the first CAM result to identify no error, (b) performing an error detection operation on a second CAM entry corresponding to the second CAM result to identify no error, and (c) identifying that the first CAM result corresponds to a higher-priority CAM entry in said priority order of said CAM entries than the CAM entry corresponding to the second CAM result.

6. The method of claim 1, comprising programming the plurality of CAM entries into a first CAM and the second plurality of CAM entries into a second CAM; wherein same entries of the first and second plurality of entries are stored at same addresses within the first and second CAMs.

7. The method of claim 1, wherein said determining which of the first or second CAM result is correct includes determining the first CAM result is correct in response to: (a) performing an error detection operation on a first CAM entry corresponding to the first CAM result to identify no error, and (b) performing an error detection operation on a second CAM entry corresponding to the second CAM result to identify an error.

8. The method of claim 1, determining the first CAM result is correct and correcting the CAM entry in the second plurality of CAM entries at the same position in said priority order as the CAM entry in the first plurality of CAM entries corresponding to the first CAM in response to: (a) performing an error detection operation on a first CAM entry corresponding to the first CAM result to identify no error, and (b) performing an error detection operation on a second CAM entry corresponding to the second CAM result to identify an error.

9. An apparatus, comprising:
means for performing a lookup operation with a lookup word on both a first plurality of content-addressable memory (CAM) entries and a second plurality of CAM entries in order to generate a first CAM result from the first plurality of CAM entries and a second CAM result from the second plurality of CAM entries, with the first and second plurality of CAM entries being the same and ordered in a same priority order; and
means for determining which of the first or second CAM result is correct and producing said determined correct first or second CAM result as the lookup result; wherein said generated first and second CAM results do not correspond to the same CAM entry respectively in the first and second plurality of CAM entries.

10. The apparatus of claim 9, wherein said means for determining which of the first or second CAM result is correct includes means for determining the first CAM result is correct in response to: (a) performing an error detection operation on a first CAM entry corresponding to the first CAM result to identify no error, (b) performing an error detection operation on a second CAM entry corresponding to the second CAM result to identify no error, and (c) identifying that the first CAM result corresponds to a higher-priority CAM entry in said priority order of said CAM entries than the CAM entry corresponding to the second CAM result.

11. The apparatus of claim 9, comprising: means for determining the first CAM result is correct and means for correcting the CAM entry in the second plurality of CAM entries at the same position in said priority order as the CAM entry in the first plurality of CAM entries corresponding to the first CAM; wherein said means for determining the first CAM result is correct and said means for correcting the CAM entry in the second plurality of CAM entries at the same position in said priority order as the CAM entry in the first plurality of CAM entries corresponding to the first CAM are both responsive to: a) means for performing an error detection operation on a first CAM entry corresponding to the first CAM result to identify no error, (b) means for performing an error detection operation on a second CAM entry corresponding to the second CAM result to identify no error, and (c) means for identifying that the first CAM result corresponds to a higher-priority CAM entry in said priority order of said CAM entries than the CAM entry corresponding to the second CAM result.

12. The apparatus of claim 9, wherein said means for determining which of the first or second CAM result is correct includes: means for performing an error detection operation on a first CAM entry corresponding to the first CAM result to identify no error; and means for performing an error detection operation on a second CAM entry corresponding to the second CAM result to identify an error.

13. The apparatus of claim 9, comprising: means for determining the first CAM result is correct and for correcting the CAM entry in the second plurality of CAM entries at the same position in said priority order as the CAM entry in the first plurality of CAM entries corresponding to the first CAM in response to: (a) performing an error detection operation on a first CAM entry corresponding to the first CAM result to identify no error, and (b) performing an error detection operation on a second CAM entry corresponding to the second CAM result to identify an error.

14. An apparatus, comprising:
a first content-addressable memory (CAM) configured to perform a lookup operation on its entries with a lookup word in order to produce a first CAM result and a first error code value;
a second CAM configured to perform a lookup operation on its entries with the lookup word in order to produce a second CAM result and a second error code value, wherein the first and second CAMs are programmed with same entries at the same locations respectively within the first and second CAMS; and
a result analyzer configured to determine a lookup result based on the first and second CAM results and the first and second error code values, wherein said configuration of the result analyzer includes: when said generated first and second CAM results do not correspond to a same entry position respectively in the first and second CAMs, determining the first CAM result as the lookup result in response to: (a) the first error code value identifying no error, (b) the second error code value identifying no error, and (c) the first CAM result corresponds to a higher-priority CAM entry than the second CAM result.

15. The apparatus of claim 14, wherein the first and second CAM are ternary content-addressable memories.

16. The apparatus of claim 14, wherein the apparatus is configured to correct the CAM entry in the second CAM at the position corresponding to the first CAM result in response to said determination of the first CAM result as the lookup result.

17. The apparatus of claim 14, wherein said configuration of the result analyzer includes: determining the first CAM result is correct in response to: (a) the first error code value identifying no error, and (b) the second error code value identifying an error; and wherein the apparatus is configured to correct the entry in the second CAM at the position corresponding to the second CAM result in response to the second error code value identifying an error.

18. An apparatus, comprising:
a first content-addressable memory (CAM) configured to perform a lookup operation on its entries with a lookup word in order to produce a first CAM result;
a second CAM configured to perform a lookup operation on the lookup word in order to produce a second CAM result, wherein the first and second CAMs are programmed with same entries in the same priority-order; and
a result analyzer configured to determine a first error code value associated with the first CAM result and a second error code value associated with the second CAM result; and to determine a lookup result based on the first and second CAM results and the first and second error code values, wherein said configuration of the result analyzer includes: when said generated first and second CAM results do not correspond to a same entry position respectively in the first and second CAMs, determining the first CAM result as the lookup result in response to: (a) the first error code value identifying no error, (b) the second error code value identifying no error, and (c) the first CAM result corresponds to a higher-priority CAM entry than the second CAM result.

19. The apparatus of claim 18, wherein the apparatus is configured to correct the CAM entry in the second CAM at the position corresponding to the first CAM result in response to said determination of the first CAM result as the lookup result.

20. The apparatus of claim 18, wherein said configuration of the result analyzer includes: determining the first CAM result is correct in response to: (a) the first error code value identifying no error, and (b) the second error code value identifying an error; and wherein the apparatus is configured to correct the entry in the second CAM at the position corresponding to the second CAM result in response to the second error code value identifying an error.
